(19) United States
(12) Patent Application Publication
(10) Pub. No.: US 2025/0021741 A1
(43) Pub. Date: Jan. 16, 2025

(54) SYSTEMS AND METHODS FOR CREATING BROADCAST CONTENT USING GENERATIVE ARTIFICIAL INTELLIGENCE

(71) Applicants: Vijay Kumar, Irvine, CA (US); Rajay Kumar, Irvine, CA (US)

(72) Inventors: Vijay Kumar, Irvine, CA (US); Rajay Kumar, Irvine, CA (US)

(21) Appl. No.: 18/770,525

(22) Filed: Jul. 11, 2024

Related U.S. Application Data
(60) Provisional application No. 63/525,966, filed on Jul. 11, 2023.

(51) Int. Cl. G06F 40/103; G06F 16/34; G06F 40/169

(52) U.S. Cl. CPC G06F 40/103; G06F 16/345; G06F 40/169

(57) ABSTRACT

Aspects of the disclosed technology provide solutions for generating summaries of a source text based on user specified content parameters. In some aspects, a process of the disclosed technology can include steps for receiving a first source text, the source text having a first textual attribute, receiving a content parameter, providing the source text and the content parameter to a machine-learning (ML) model, and receiving, from the ML model, a proto text based on the source text and the content parameter, wherein the proto text has second textual attribute, and wherein the second textual attribute is different than the first textual attribute. Systems and machine-readable media are also provided.

### CROSS-REFERENCE TO RELATED APPLICATIONS

The present application claims the benefit of U.S. Provisional Application No. 63/525,966, filed on Jul. 11, 2023, which is hereby incorporated by reference in its entirety.

### BACKGROUND

### 1. Technical Field

The present disclosure generally relates to written summaries and in particular, for solutions for facilitating the research and summarization of one or more source text documents based on user provided parameters.

### 2. Introduction

Machine-learning models, such as Large Language Models (LLMs), can summarize source text by leveraging their neural network architecture, which is trained on vast amounts of diverse data. When tasked with summarization, an LLM first encodes the source text into a series of vectors that capture the semantic meaning of the content, and then processes these vectors to identify key information, essential points, and the overall context of the source text.

Using attention mechanisms, LLMs can focus on the most salient parts of the input source text while minimizing less critical details. The decoder part of the model generates a concise summary by constructing sentences that convey the core message of the original text. This process involves selecting relevant words and phrases, organizing them coherently, and ensuring that the summary is logically structured. In some instances, LLMs can produce abstractive summaries, which create new sentences based on the understanding of the text, or extractive summaries, which pull key sentences directly from the source. One limitation of the use of conventional LLMs for generating text summaries is that the summarized text tends to be overly verbose, and therefore not well suited to certain presentation formats, such as for narrative summaries that are commonly used in the presentation of news information. Additionally, conventional LLMs are not well suited for generating stylized output summaries that are often used in a web-based or televised presentation format, such as news banners or teases.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates a user interface that can be used to facilitate user interaction with a summarization system, according to some examples of the disclosed technology;

FIG. 2 illustrates a communication diagram of a summarization system where a user provided source text and preference parameters are provided to a machine learning (ML) model for generating a proto text (summary), according to some aspects of the disclosed technology;

FIG. 3 illustrates a flow diagram of a summarization system as implemented in a broadcast environment, according to some aspects of the disclosed technology;

FIG. 4 illustrates a flowchart of a process for generating a summary from a source text using a machine-learning model and a content parameter, according to some aspects of the disclosed technology;

FIG. 5 illustrates an example of a deep learning neural network that can be used to implement a summarization system, according to some aspects of the disclosed technology; and

FIG. 6 illustrates an example processor-based system with which some aspects of the subject technology can be implemented;

FIGS. 7A-7K show example screen captures from a user interface of a processor-based system from which some aspects of the subject technology can be implemented;

FIGS. 8A-8C show example screen captures of a user interface of a processor-based system including information from a news source;

FIGS. 9A-9D show example screen captures from a user interface of a processor-based system from which some aspects of the subject technology can be implemented;

FIGS. 10A and 10B show example screen captures of a user interface of a processor-based system including information from a plurality of news sources;

FIGS. 11A and 11B show example screen captures from a user interface of a processor-based system from which some aspects of the subject technology can be implemented;

FIG. 12 shows an example of how some aspects of the subject technology analyze and/or organize information from one or more news sources into automatically summarized news content;

FIG. 13 shows an example of how some aspects of the subject technology analyze and/or organize information from one or more news sources into automatically summarized news content;

FIG. 14 shows an example architecture of some aspects of the subject technology; and

FIG. 15 illustrates a flowchart of a process for enabling a presentation of a news story using automatically summarized news content based on one or more sources, in accordance with some aspects of the subject technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

News writing and broadcast journalism face several significant challenges that impact the efficiency and quality of media production. Initially, the research process, which often relies on synthesizing information from several different news sources (e.g., AP, Reuters, etc.), is laborious and time-consuming, and often requires sifting through vast amounts of information to verify facts to ensure reporting accuracy and completeness. Additionally, summarizing articles is a demanding task that requires the distillation of information into concise and understandable segments that are presentable in the intended target format or style, such as for use in distribution in web articles, banners, teases, and/or broadcast news releases that are prepared for voice over (VO) presentation. Broadcast journalism presents additional challenges, in that the news summaries must be narrated within strictly allotted time slots, without losing the essence or accuracy of the original content.

Aspects of the disclosed technology provide solutions for facilitating the summarization, reformatting, and editing of source content based on user-indicated preferences (or user parameters). As discussed in further detail below, the indicated user parameters can be used to generate specific prompts that are provided to a machine-learning (ML) system, such as a Large Language Model (LLM), along with the source text, to produce a desired summary output. Depending on the desired implementation, one or more different user parameters may be used to generate a summary (also proto text or proto summary) of a source text. In some approaches, the summary may be generated from two or more sources, such as by combining information (e.g., news reporting) from multiple different sources. In some aspects, content parameters are provided to specify attributes of content. A content parameter, as used herein, can include a parameter related to one or more attributes of content. Examples of content parameters include: narrative length parameters, e.g., a parameter to specify a length and/or duration of content, a parameter to specify duration of a presentation of content, a parameter to specify a cadence of a presentation of content, a parameter to specify a presentation speed of a presentation of content, a parameter to specify speech attributes related to a presentation of content, a parameter to specify a narrative style of a presentation of content, a parameter to specify any combinations thereof, etc.

In some aspects, a user provided narrative length parameter may be used to indicate a desired narrative length of the resulting summary, e.g., for dissemination via broadcast channels (e.g., television, podcast, or radio, etc.) in a voice over format. Provided user parameters may also be used to indicate a desired style for the summary and/or a use or intended audience of the summary. As discussed in further detail below.

Automated summarization systems, such as those disclosed herein can significantly enhance the efficiency of workflows for news editors by summarizing news text for different distribution channels. By automatically generating concise and coherent summaries, the disclosed summarization system reduces the time editors spend manually condensing articles, allowing them to focus on higher-level editorial tasks, thereby reducing staffing costs associated with summarization and research tasks. By integrating summarization systems into their workflow, news organizations can achieve faster, more cost-effective, and more reliable content production, enhancing their competitive edge in the fast-paced media landscape.

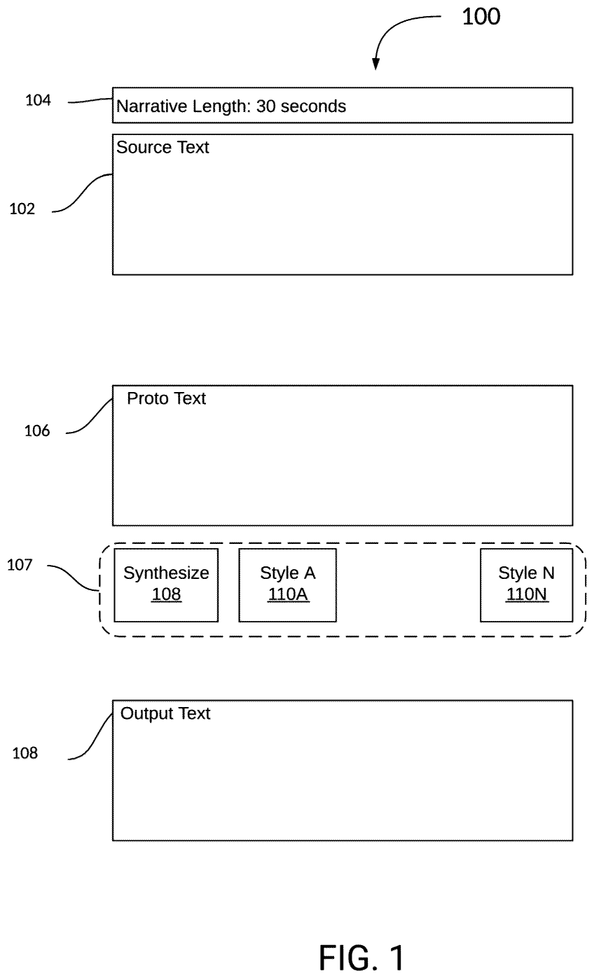

FIG. 1 illustrates an example user interface 100 that can be used to facilitate user interaction with a summarization system. User interface 100 includes several graphical elements such as a source text input field 102, a narrative length input field 104, a proto text output field 106, selectable user parameters 107, and output text field 108. Using the various input fields and user-selectable options provided by user interface 100, a user may synthesize, summarize and edit one or more source text inputs, for different target output types. As discussed in further detail below, user provided inputs via interface 100 can be used by a summarization system (or summarization module) to generate specific prompts that elicit LLM modifications to the source text according to the user's provided specifications.

In operation, one or more source text/s can be provided to a summarization system via source text input field 102, e.g., using a copy/paste command. The source text can be of any length and may be inputted manually or alternatively imported from a specified source. For example, the user interface may allow the user to specify a location (e.g., a URL) of the source text/s. If voice-over (VO) outputs are desired, a user specified narrative-length parameter can be provided via narrative length input field 104. For example, if a VO narration of the resulting summary cannot last more than 30 seconds, then the user may specify “30 seconds” to ensure that the resulting summary (or proto text) can be narrated in the specified length of time. As such, the narrative length parameter can serve as an upper threshold for an amount of time allotted for narration of the generated proto text, for example, which can be displayed back to the user via proto text output field 106. It is understood that other time durations may be specified by the user, without departing from the scope of the disclosed technology.

Summarized output text (proto text) displayed in output field 106 can be further modified or edited by the user, either manually, by providing edits directly to the text in output field 106, or by using one or more selectable parameters 107. For example, automatic corrections may be made to change or improve grammar, punctuation, spelling, and/or readability, etc. In some aspects, editing may be performed to increase or decrease the reading level of the resulting proto text, for example, to adapt the diction of the summary for easier consumption by different audiences, such as young children. In some instances, selectable parameters 107 may provide an option to adapt the proto text (summary) into another language, or into a style that is better consumed by non-native speakers of the target language.

Synthesis of the proto text summary with one or more additional information sources can be initiated through user selection of synthesize option 108. By way of example, once a proto text summary is displayed in output field 106, the user may provide additional source text information in source text input field 102 and combine/synthesize the two (or more) information sources through selection of synthesize option 108. Editing of the proto text output into other presentation formats, such as into a banner format, a news tease format, a web article format, or any other format may be done through user selection/engagement with any of selectable content (style) parameters 110 (e.g., 110A . . . 110N). In some implementations, style parameters 110 may also be used to make other changes, such as changing the narrative/voice-over length, or generating a story format of the proto text output, etc. It is understood that various other style and/or editing options may be provided by selectable style parameters 110, without departing from the scope of the disclosed technology.

The final edit of the proto text can be submitted to an intended recipient directly from user interface 100. As such, user interface 100 can provide an entry point for user access to an end-to-end publication workflow to help users achieve a faster, more cost-effective, and reliable content production pipeline. The finally edited summary, along with metadata indicating the selected user parameters, can be used to further refine/train the summarization module and/or

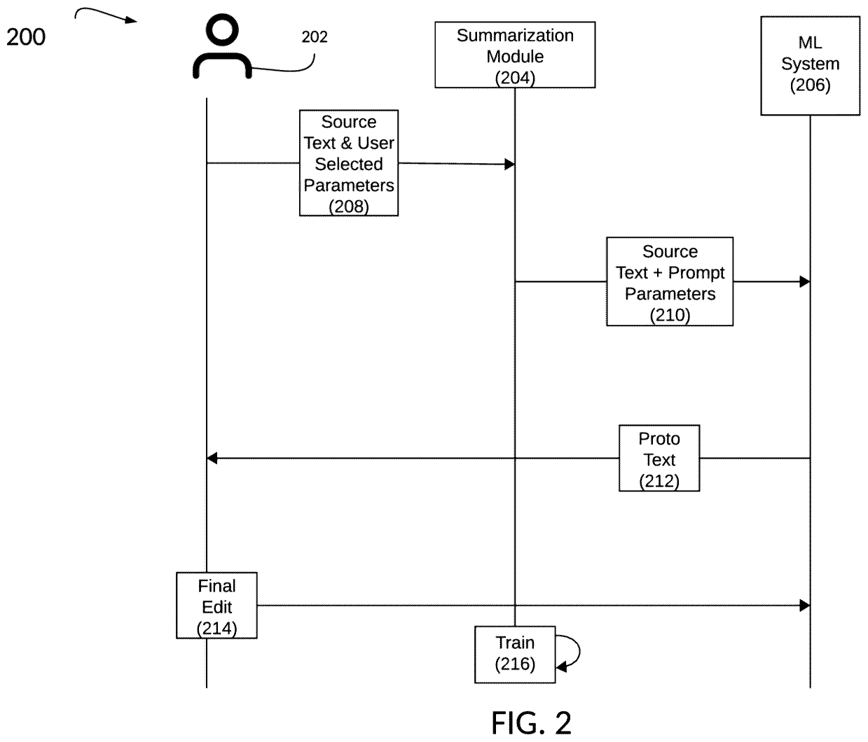

LLM, as discussed in further detail below. With further training the summarization module can improve with use, over time to improve its generation of specific prompt parameters, for example that are provided along with the source text to an ML system (e.g., an LLM) that ultimately provides the proto text output. Further details regarding the function of the summarization module in conjunction with an ML system are described with respect to FIG. 2.

FIG. 2 illustrates a communication diagram of a summarization system 200 that includes a summarization module 204 and ML system 206. Summarization module 204 can be configured to receive source text and user preferences/parameters and to interact with ML system 206 to generate summaries and/or edits of the source text. For example, summarization system 200 can be configured to receive user selected parameters 208, and based on the analyzed parameters, construct a detailed prompt that is appended (or prepended) to the source text to enable ML system 206 to make the desired edits to the source text. It is understood that ML system 206 can include any of a variety of generative ML components, and may be, for example, an LLM system.

In the communication diagram of summarization system 200, at block 208, user 202 can provide (e.g., via user interface 100) one or more source texts, together with one or more selected content parameters to summarization module 204. The user selected content parameters can include a narrative length parameter, specifying a maximum amount of time for narration of a summary of the source text, e.g., for a voice over presentation. Additionally, or alternatively, the user selected content parameters can include stylistic choices, for example, to generate a banner, or a tease based on the information contained in the source text. By way of further example, content parameters include one or more of: a duration parameter to specify duration of the presentation, a cadence parameter to specify a cadence of the presentation, a presentation speed parameter to specify a presentation speed of the presentation, a speech attribute parameter to specify speech attributes related to the presentation of content, a narrative style parameter to specify a narrative style of the presentation, or some combination thereof. It is understood that virtually any type of stylistic selection can be conveyed by user 202 via one or more selected content parameters.

Once the source text/s and user selected parameters (208) are received by summarization module 204, the module can generate one or more prompt parameters that encapsulate all user specifications for the intended output or proto text, for example, possibly structured as a set of instructions or a detailed description of the intended output. By way of example, summarization module 204 may include one or more algorithms or ML models that are optimized to determine how long a particular summary of the source text may be (e.g., a word count), while also being presentable in a VO format within a time indicated by the user selected content parameters (e.g., a narrative length parameter) provided by user 202. That is, summarization module 204 can be configured to generate the specific prompt parameters that enable ML system 206 to summarize the source text into a length (e.g., a word count of phoneme count) fitting the temporal requirements of user 202.

Irrespective of the user's specific content parameter selections, the prompt parameters generated by summarization module 204 are provided, along with the source text (210) to the ML system 206, which can summarize and edit the source text accordingly. The resulting summary (proto text) can then be communicated back to the user 202, either directly, or via summarization module 204 (block 212).

In some implementations, proto text 212 may be a summarization of the source text that is provided in format that is more adapted for broadcast news presentation (e.g., in all caps), and/or that is truncated in a way that is optimized for VO narration. For example, the proto text can be reduced by word count and/or phoneme count for better adaptation for narration in a broadcast news format. Additionally, the proto text may be provided in another style, such as for adaptation as a web article, banner, news tease, or in any other style desired by user 202.

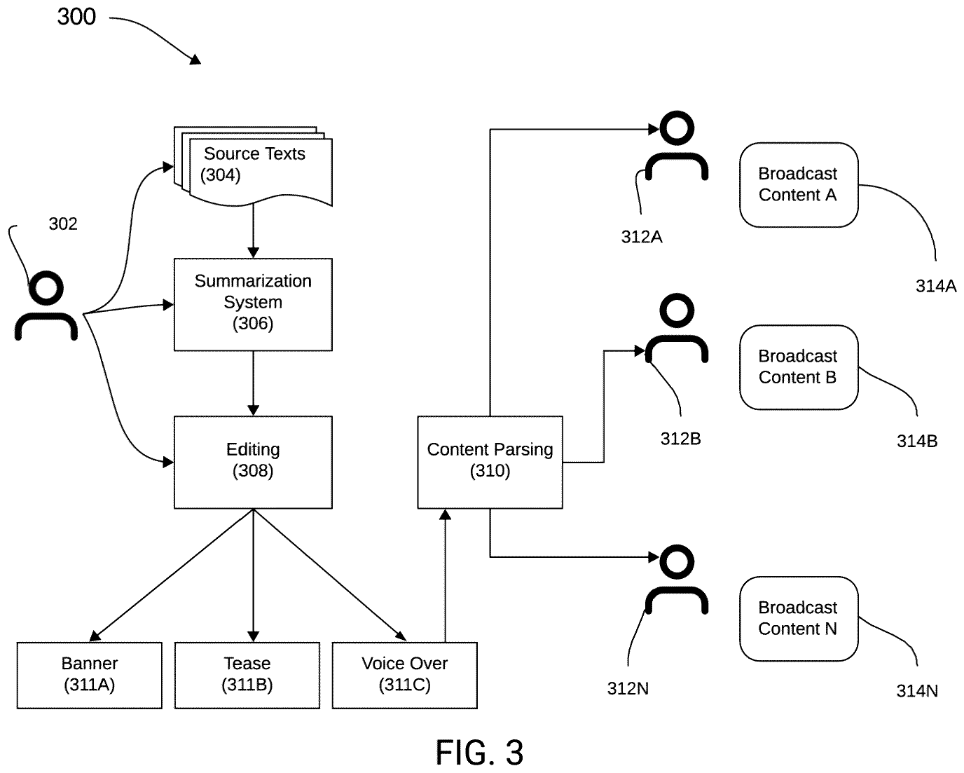

The proto text can then be further edited, either manually by user 202, or using additional prompt parameters provided to ML system 206. The final edited version of the summarized text can be used to further train or refine one or more ML models or prompt generation algorithms of summarization module 204. For example, the final edits may be used to improve prompt parameters generated by summarization module 204 based on the received user selected parameters. Additional training in this way can improve the prompt parameter generation over time, thereby improving the ability of summarization module 204 to engage with ML system 206 to meet the user's specific stylistic and editing requirements. In some approaches, the final edit 214 can be provided directly into a workflow chosen by user 202, such as a news production workflow, as discussed in further detail with respect to FIG. 3.

FIG. 3 illustrates a flow diagram of a summarization system that is implemented in a broadcast environment 300. In operation, a user 302 can provide one or more source texts 304 to a summarization system 306 that is configured to summarize, edit, and/or stylize the source text 304 according to one or more user provided parameters, as discussed above. In some instances, source text 304 can be provided manually (e.g., via a copy/paste command) into a user interface (e.g., UI 100) of summarization system 306. In other approaches, source text 304 may be linked via a URL or other means, and automatically retrieved from one or more online resources by summarization system 306.

In some configurations, summarization system 306 may also be configured to generate imagery or animations that convey information about the source text. For example, summarization system 306 may be configured to generate video content that conveys or depicts the content or key facts of a particular news story, such as in a story format, or as an imagined reenactment of events described by the source text. Outputs of summary system, including any generated proto text, images, and/or videos etc., may be further edited by the user (block 308) before final production and publication. By way of example, edited proto text can be used to generate various types of summaries 311 in different styles/formats, such as one or more banner 311A, tease 311B, and/or voice over (VO) 311C outputs.

As discussed above, the summarization system 306 may be configured to ship or publish generated summaries 311, e.g., in a broadcast and streaming ready format via connection to a complete news publication or broadcasting workflow, such as iNews. In such approaches, all (or portions) of output summary content 311 may be parsed (310) for delivery to multiple different journalists, news anchors, and/or other content editing or publishing professionals. By way of example, summary content 311 can be parsed between multiple end-users 312 (such as broadcast journalists, 312A, 312B, 312C), where each can present a portion of VO content 311C via a respective teleprompter (314A, 314B, 314C).

If desired, further editing can be performed by end-users 312, for example to turn facts into a story, autocorrect the summary text and/or facts, and/or to change the narrative length of the summary, e.g., from 30 seconds to 15 seconds, or 60 seconds, etc. By way of example, the summarization system 306 may be used to turn concise or dense (lists) of facts into a story format. The autocorrect feature may be used to automatically validate the proto text for semantics, structure, grammar, punctuation, sentence structure and word count, etc. In some implementations, content parameter options may be provided as a single selectable option, e.g., to generate a banner, a tease, and VO content using only a single selectable option.

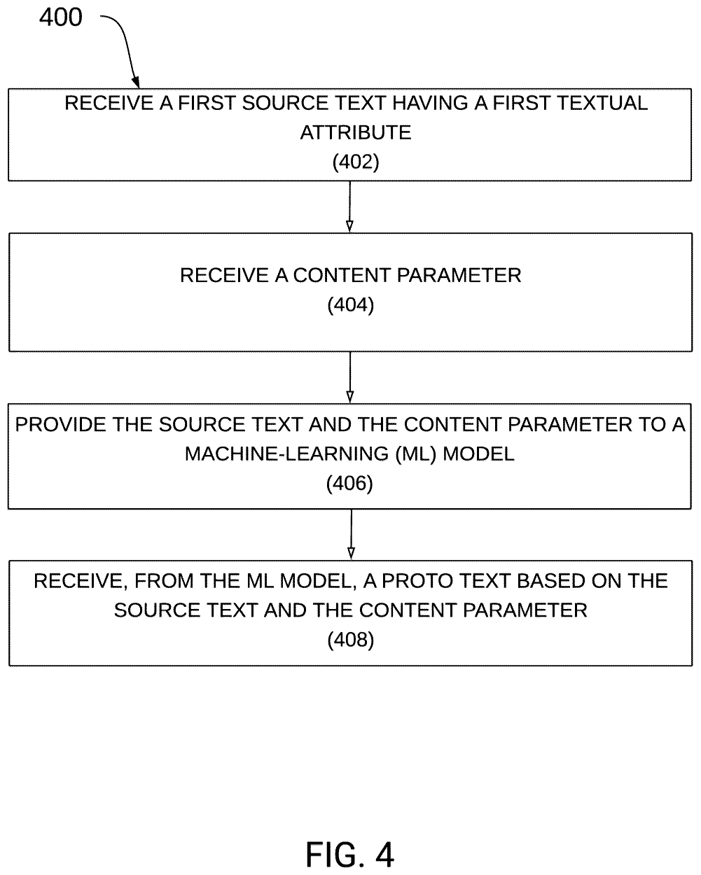

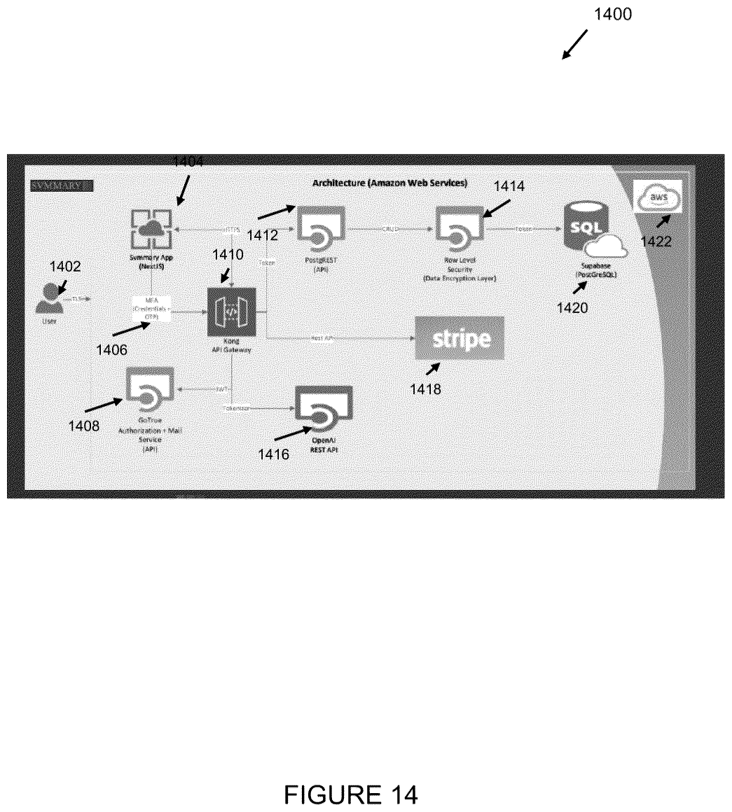

FIG. 4 illustrates a flowchart of a process 400 for generating a summary from a source text using a machine-learning model and a content parameter. At step 402, the process 400 includes receiving a first source text having a first textual attribute (e.g., a first word count). The source text may be manually provided by a user, e.g., via a user interface configured to work in conjunction with a summarization system of the disclosed technology. In practice, the source text can be provided to a summarization system using a copy/paste command. The source text can be of any length and may be inputted manually or imported automatically a specified source, for example, that is identified by a URL or other resource link. As illustrated in FIG. 14, and discussed in further detail below, the source text may be retrieved from one or more remote computing systems (servers), for example, via an Application Programming Interface (API), or the like.

At step 404, the process 400 includes receiving a desired content parameter (narrative length parameter) for the resulting summary, e.g., for dissemination via broadcast channels (e.g., television, podcast, or radio, etc.) in a voice over format. Provided content parameters may also be used to indicate a desired style for the summary and/or a use or intended audience of the summary, as discussed above.

At step 406, the process 400 includes providing the source text and the content parameter to a machine-learning (ML) model.

At step 408, the process 400 includes receiving, from the ML model, a proto text based on the source text and the content parameter, wherein the proto text has a second textual attribute (e.g., a second word count), and wherein the second textual attribute is different than the first textual attribute. For example, the second word count (second textual attribute) of the resulting proto text can be less than the first word count (first textual attribute) of the source text, e.g., where the proto text is a summary of the source text. In another example, the second word count may be greater than the first word count, for example where the proto text is a story (such as a news story) that is generated from a source text that includes a concise statement (or list) of facts.

Summarized output text (proto text) can be further modified or edited by the user, manually, by providing edits directly to the text. In some approaches, automatic corrections may be made to change or improve grammar, punctuation, spelling, and/or readability, etc. In further examples, editing may be performed to increase or decrease the reading level of the resulting proto text for consumption by different audiences.

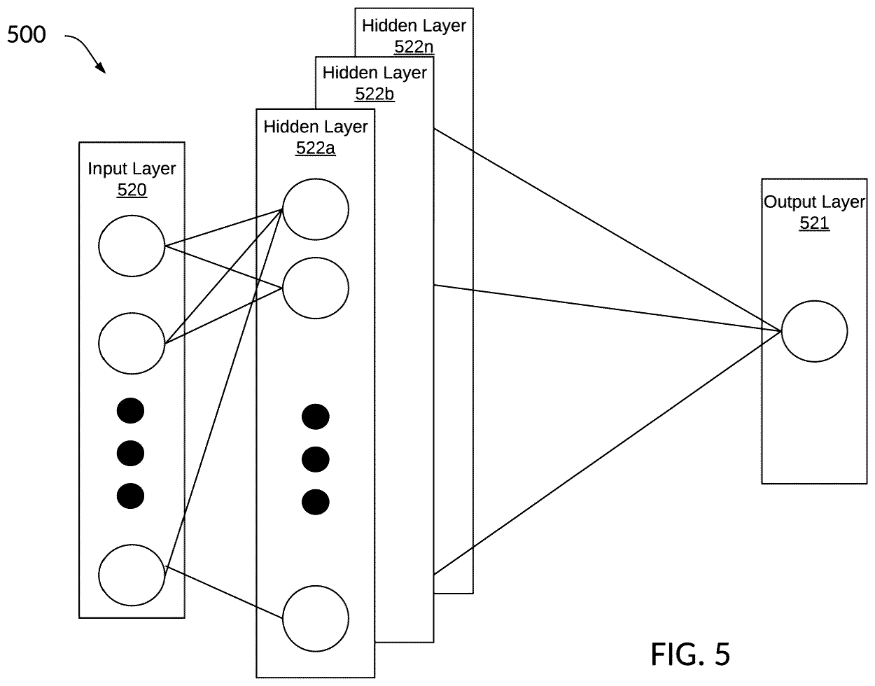

In FIG. 5, the disclosure now turns to a further discussion of models that can be used through the environments and techniques described herein. FIG. 5 is an example of a deep learning neural network 500 that can be used to implement all or a portion of the systems and techniques described herein. For example, neural network 500 can be used to implement a summarization module (e.g., summarization module 204, or an ML system such as ML system 206 (an LLM) as discussed above).

Neural network 500 is a multi-layer neural network of interconnected nodes. Each node can represent a piece of information. Information associated with the nodes is shared among the different layers and each layer retains information as information is processed. In some cases, the neural network 500 can include a feed-forward network, in which case there are no feedback connections where outputs of the network are fed back into itself. In some cases, the neural network 500 can include a recurrent neural network, which can have loops that allow information to be carried across nodes while reading in input.

Information can be exchanged between nodes through node-to-node interconnections between the various layers. Nodes of the input layer 520 can activate a set of nodes in the first intervening layer 522a. For example, as shown, each of the input nodes of the input layer 520 is connected to each of the nodes of the first intervening layer 522a. The nodes of the first intervening layer 522a can transform the information of each input node by applying activation functions to the input node information. The information derived from the transformation can then be passed to and can activate the nodes of the next intervening layer 522b, which can perform their own designated functions. Example functions include convolutional, up-sampling, data transformation, and/or any other suitable functions. The output of the intervening layer 522b can then activate nodes of the next intervening layer, and so on. The output of the last intervening layer 522n can activate one or more nodes of the output layer 521, at which an output is provided. In some cases, while nodes in the neural network 500 are shown as having multiple output lines, a node can have a single output and all lines shown as being output from a node represent the same output value.

In some cases, each node or interconnection between nodes can have a weight that is a set of parameters derived from the training of the neural network 500. Once the neural network 500 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 500 to be adaptive to inputs and able to learn as more and more data is processed.

Neural network 500 can include any suitable deep network. One example includes a Convolutional Neural Network (CNN), which includes an input layer and an output layer, with multiple intervening layers between the input and out layers. The intervening layers of a CNN include a series of convolutional, nonlinear, pooling (for down sampling), and fully connected layers. The neural network 500 can include any other deep network other than a CNN, such as an autoencoder, Deep Belief Nets (DBNs), Recurrent Neural Networks (RNNs), among others.

Neural network 500 may also include, or may be, any of a variety of generational ML models, including but not limited to one or more Generative Adversarial Networks (GANs), transformers, and/or attentional networks, and the like.

For generative ML approaches, such as applications utilizing an LLM as discussed above, input (embedding) layer 520 can be configured to receive source text data, and convert the source text into token embeddings, e.g., into dense vectors of a fixed size. The embedding layer 520 can also add positional encodings. Depending on the desired implementation, the parameter size of embedding layer 520 may vary, for example, token embeddings may require 50,000×2048=102,400,000 parameters. Neural network 500 also includes multiple intervening layers 522a, 522b, through 522n. Layers 522a, 522b, through 522n include “n” number of intervening (hidden) layers, where “n” is an integer greater than or equal to one.

Intervening layers 522a, 522b, through 522n can include encoder-decoder structure/s, wherein encoding structures can consists of layers with Multi-Head Self-Attention, Feed-Forward Network (FFN), and Add & Norm (layer normalization and residual connections). The Multi-Head Self-Attention mechanism/s can facilitate dynamic focusing on different segments of input data for parallel processing, enhancing the contextual relevance of the processed information. The FFNs can be integrated within each layer, structured to process the output from the self-attention mechanism sequentially, ensuring robust data transformation capabilities. And the Add & Norm component, which can incorporate layer normalization and residual connections, can be used to stabilize the learning process and enhance the convergence speed of the model by combining input and output of prior layers and normalizing the results. The number and parameter size of intervening layers can be made to include as many layers/parameters as needed for the given application. By way of example, attention mechanisms may include approximately 48 billion parameters. Feed forward network layers may include approximately 96 billion parameters

Decoder structures may be similar to encoder structures but can include cross-attention mechanisms for incorporating encoder output information. Neural network 500 further includes an output layer 521 that provides an output (e.g., pro text) resulting from the processing performed by intervening layers 522a, 522b, through 522n. The number and parameter size of the output layer can also be made to include as many parameters as needed for the given application. By way of example, output layer 521 may include approximately 102.4 million parameters.

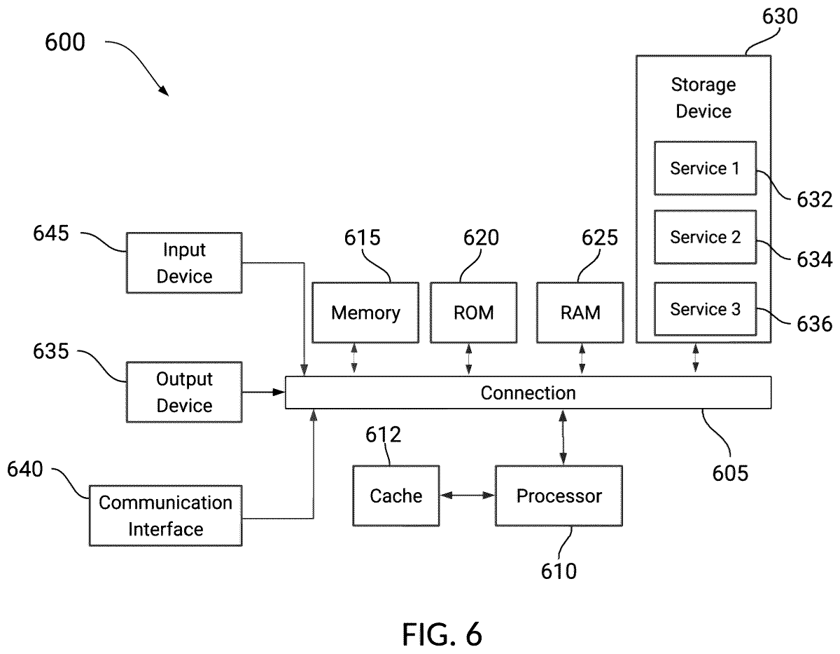

FIG. 6 illustrates an example processor-based system with which some aspects of the subject technology can be implemented. For example, processor-based system 600 can be any computing device making up, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

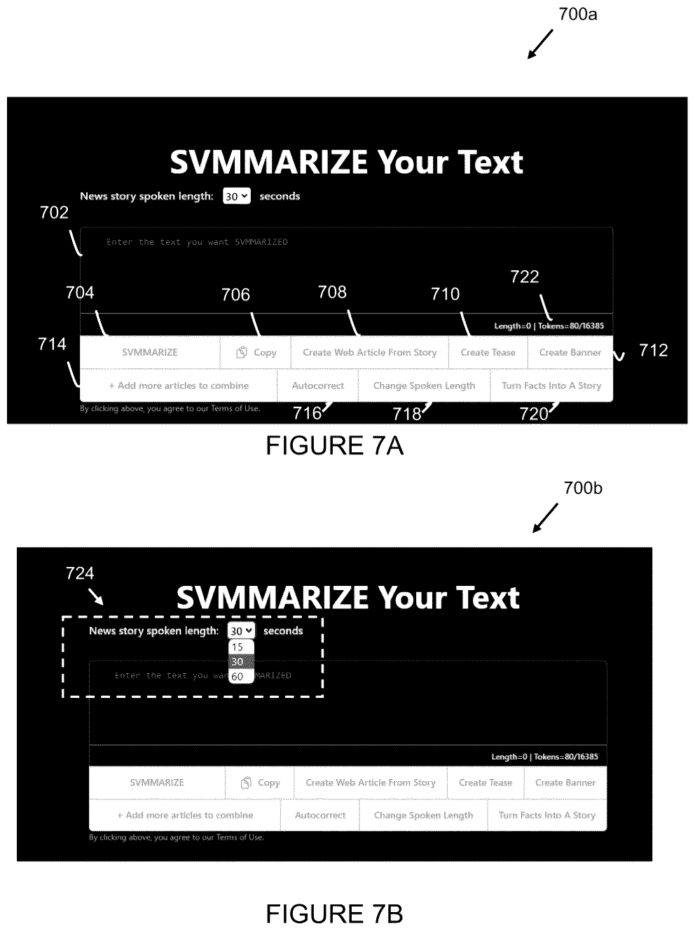

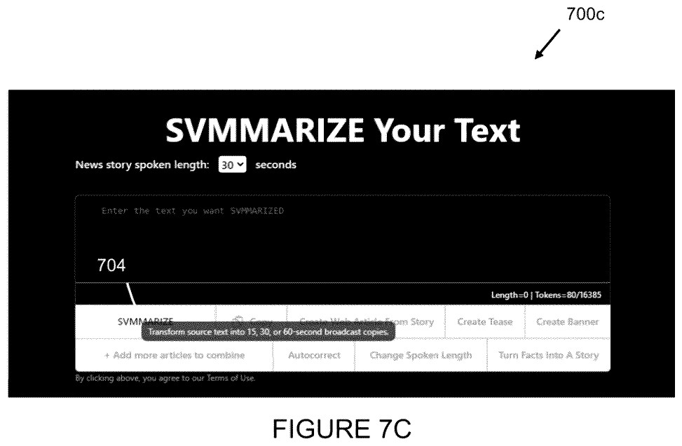

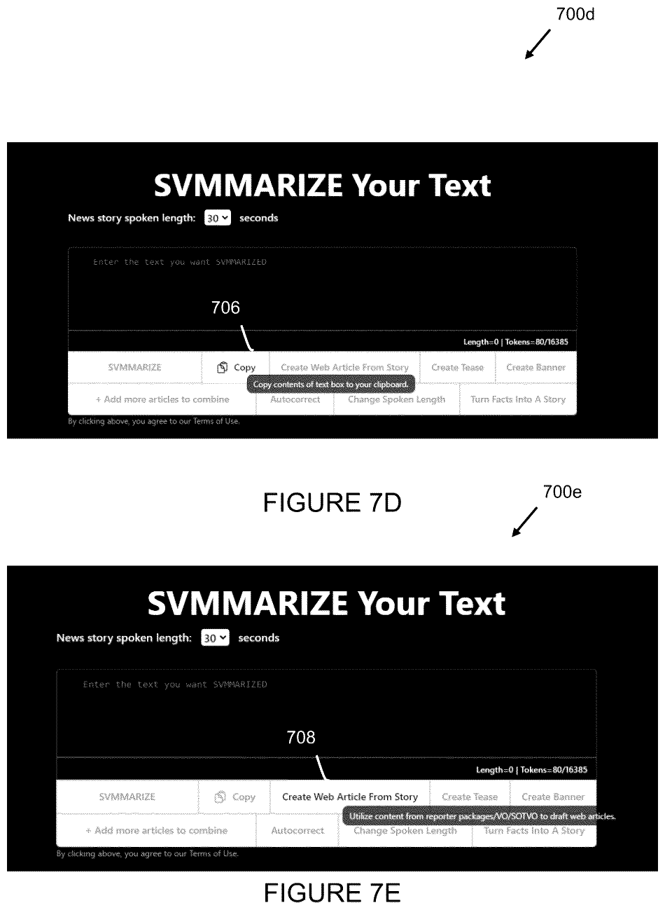

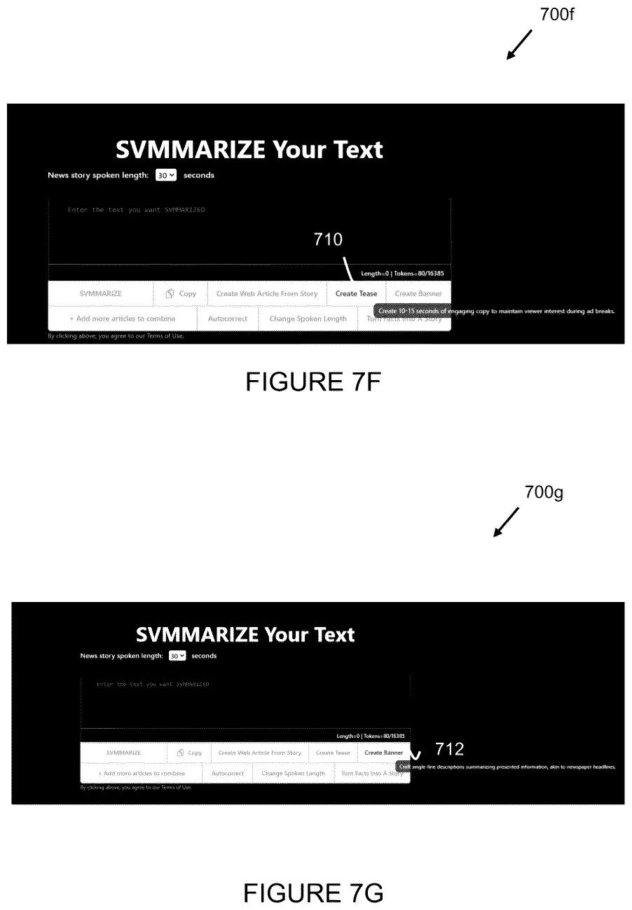

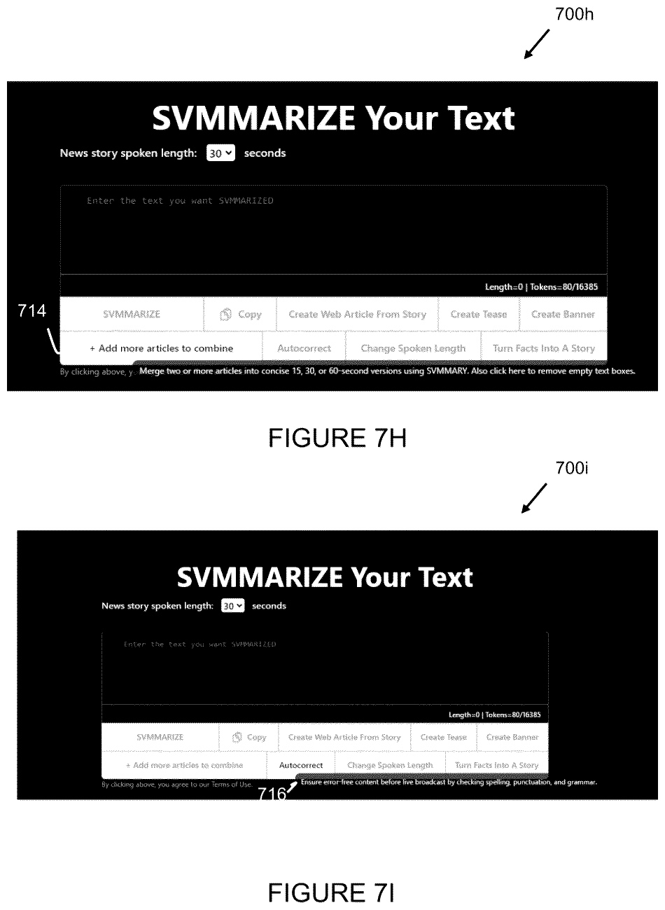

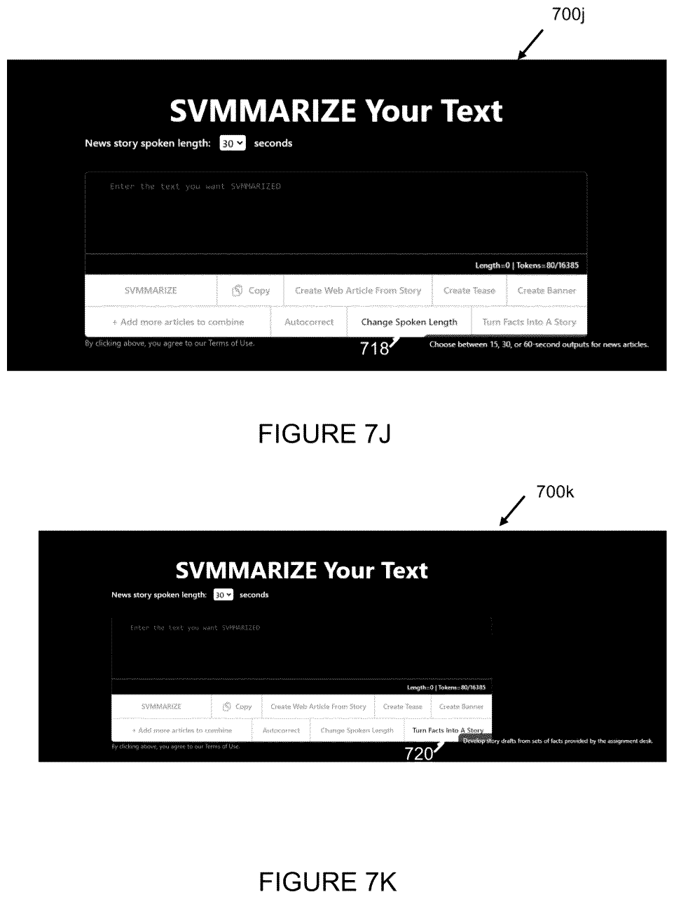

FIGS. 7A-7K show example screen captures 700a-700k from a user interface of a processor-based system from which some aspects of the subject technology can be implemented. The inventors have built a system that enables a presentation of a news story using automatically summarized news content based on one or more sources. The implementation shown in FIGS. 7A-7K is meant to be illustrative and it is noted that various implementations can take different forms. The screen captures 700 include: a text entry UI clement 702, an automatic summary UI element 704, a copy UI element 706, a web article creation UI element 708, a tease creation UI element 710, a banner creation UI element 712, an article addition UI element 714, an autocorrect UI element 716, a spoken length modification UI element 718, a story creation UI element 720, a string length/token length indicator 722, and a spoken length modification UI element 724. The UI elements are shown as entry boxes, buttons, drop down UI elements, etc., but it is noted that various UI elements can implement any of the functionalities described herein.

In the example of FIG. 7B, the spoken length modification UI element 724 comprises a drop-down UI element showing three spoken lengths (15, 30, and 60 seconds). In the example of FIG. 7C, selecting the automatic summary UI element 704, shown as a button, allows transformation of source text into broadcast copies of various lengths. In the example of FIG. 7D, selecting the copy UI element 706, shown as a button, copies the contents of the text entry UI element 702 to a user's clipboard. In the example of FIG. 7E, selecting the web article creation UI element 708, shown as a button, uses content from reporter packages,/VO/SOTVO to draft web articles. In the example of FIG. 7F, selecting the tease creation UI element 710, shown as a button, creates short (e.g., 10-15 second) engaging copy to maintain viewer interest, e.g., during ad breaks. In the example of FIG. 7G, selecting the banner creation UI element 712, shown as a button, creates single-line descriptions summarizing presented information; this can be analogized to newspaper headlines.

In the example of FIG. 7H, selecting the article addition UI element 714, shown as a button, merges two or more articles into concise versions. In the example of FIG. 71, the autocorrect UI element 716, shown as a button, evaluates content for errors by checking spelling, punctuation, grammar, readability, etc. In the example of FIG. 7J, the spoken length modification UI element 718, shown as a button, allows choices of multiple length outputs for news articles. In the example of FIG. 7K, the story creation UI element 720, shown as a button, allows development of story drafts from sets of facts provided by an assignment desk.

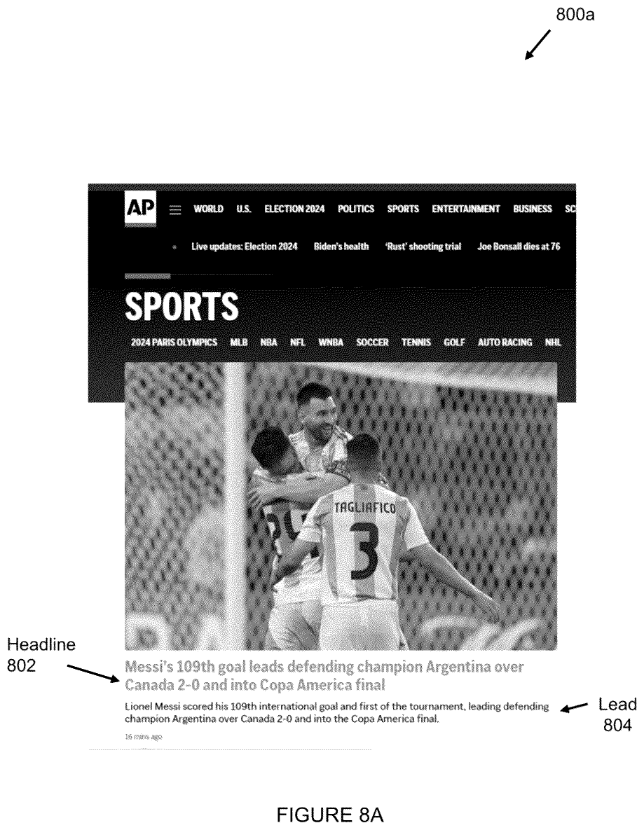

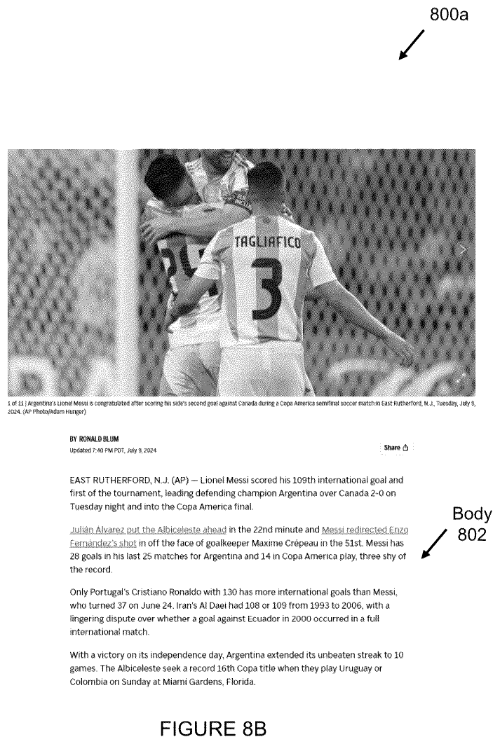

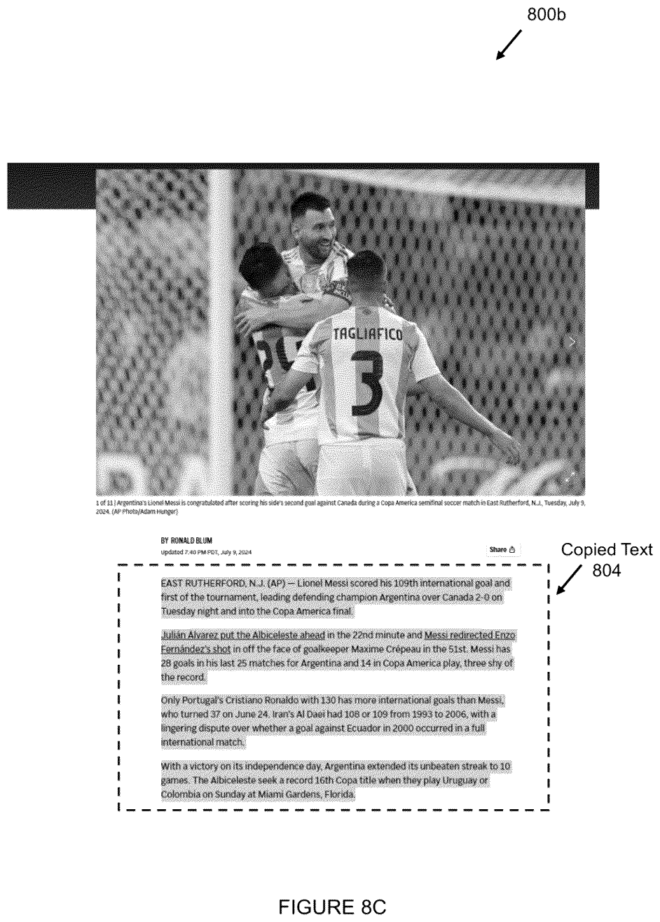

FIGS. 8A-8C show example screen captures 800a and 800b of a user interface of a processor-based system including information from a news source. In the example of FIGS. 8A-8C, a news story comprising a body 802 has been copied as copied text 804 by a user. The user will paste the text into a news summarization system.

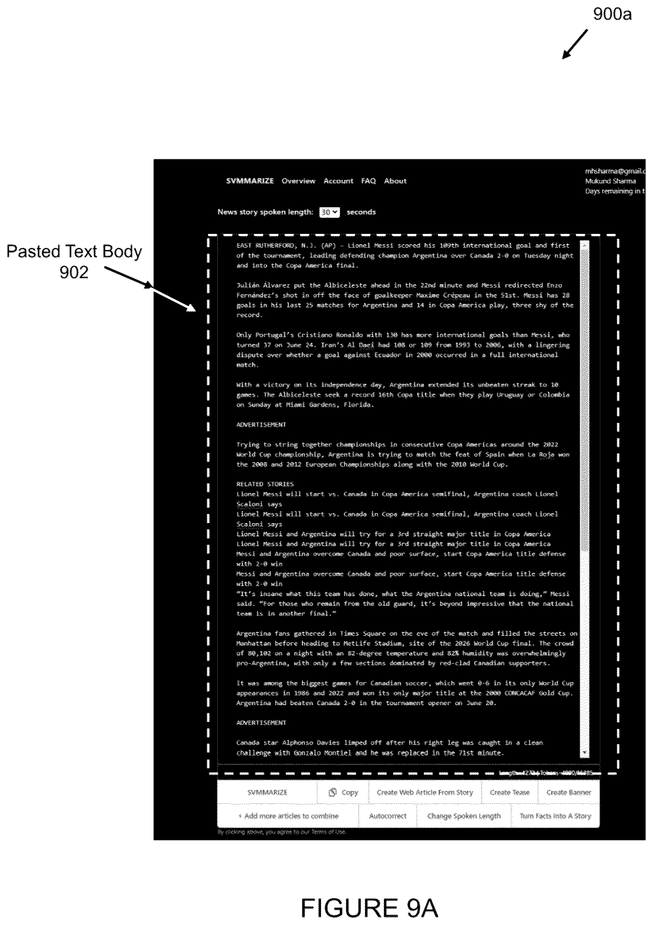

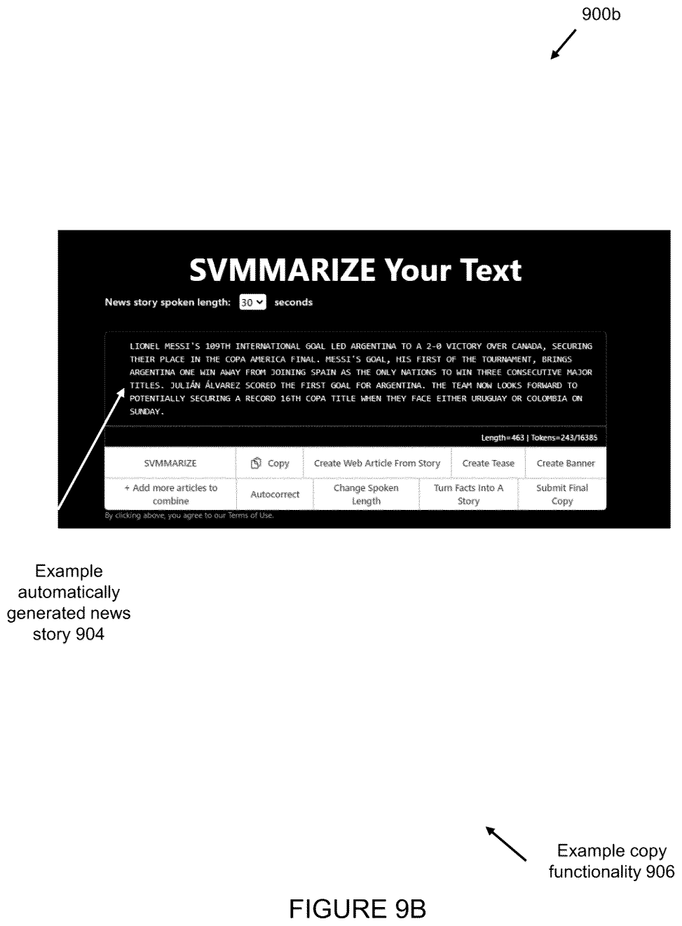

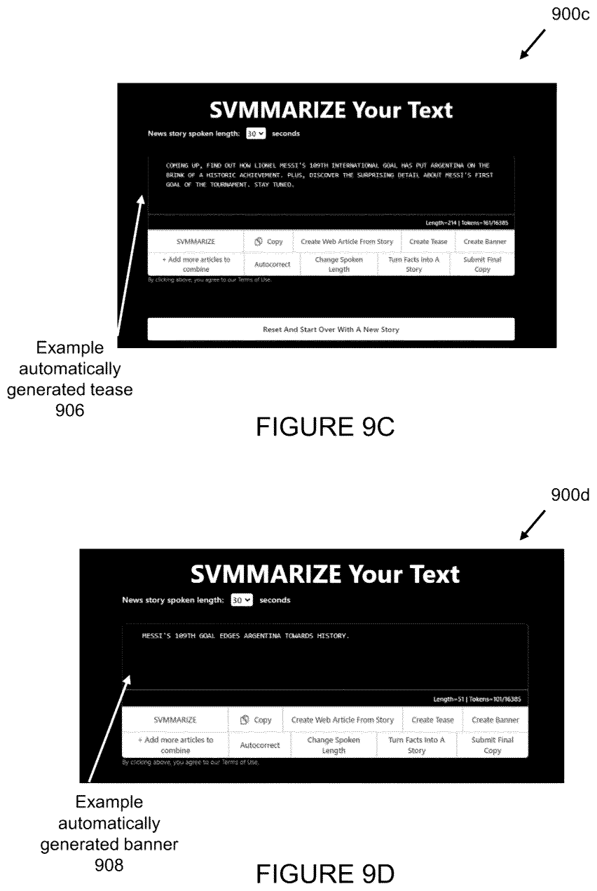

FIGS. 9A-9D show example screen captures 900a-900d from a user interface of a processor-based system from which some aspects of the subject technology can be implemented. In the example of FIG. 9A, the copied text 804 (shown in FIG. 8C has been entered into a text entry UI element (e.g., text entry UI element 702). A news story spoken length of 30 seconds has been selected. A user can further select an automatic summary UI element (e.g., automatic summary UI element 704 shown in FIG. 7A) to transform the copied text 804 into a broadcast copy of 30 seconds. In FIG. 9B, the copied text 804 has been transformed, without human intervention, into an example automatically generated news story 904. The example automatically generated news story 904 conforms to content parameters, e.g., length, structure, format, etc. An example copy functionality 906 allows the user to copy an automatically generated news story to their clipboard. In the example of FIG. 9C, an example automatically generated tease 906 has been created using the copied text 804 and a tease creation UI element (e.g., tease creation UI element 710 shown in FIG. 7A). In the example of FIG. 9D, an example automatically generated banner 908 has been created using the copied text 804 and a banner creation UI element (e.g., banner creation UI element 712 shown in FIG. 7A).

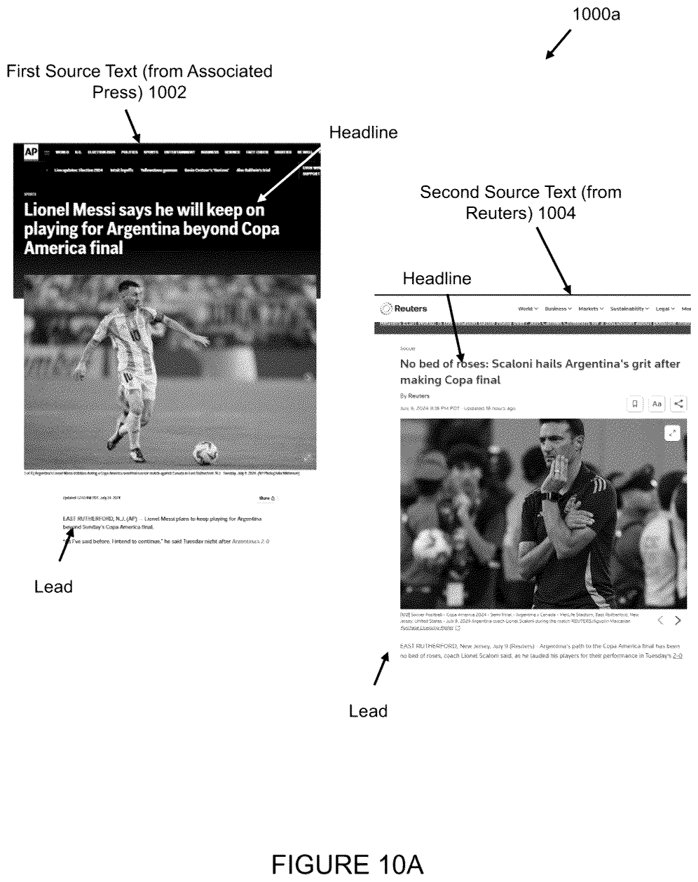

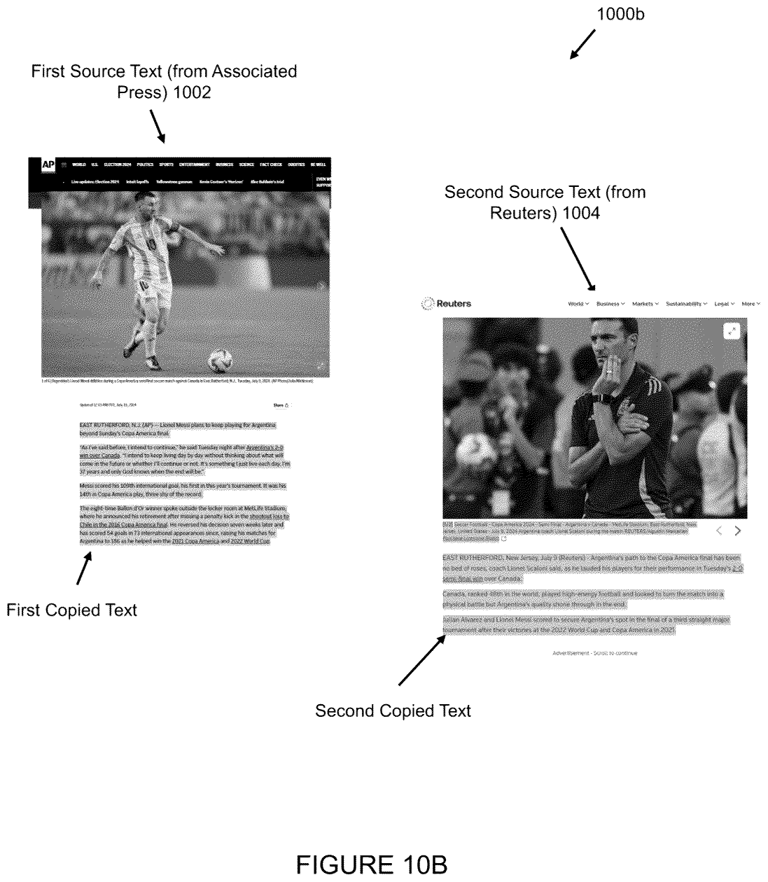

FIGS. 10A and 10B show example screen captures 1000a and 1000b of a user interface of a processor-based system including information from a plurality of news sources. First source text 1002 captured from an Associated Press article and second source text 1004 from a Reuters article is shown. Both include headlines and leads. Text is copied from both first source text 1002 and second source text 1004.

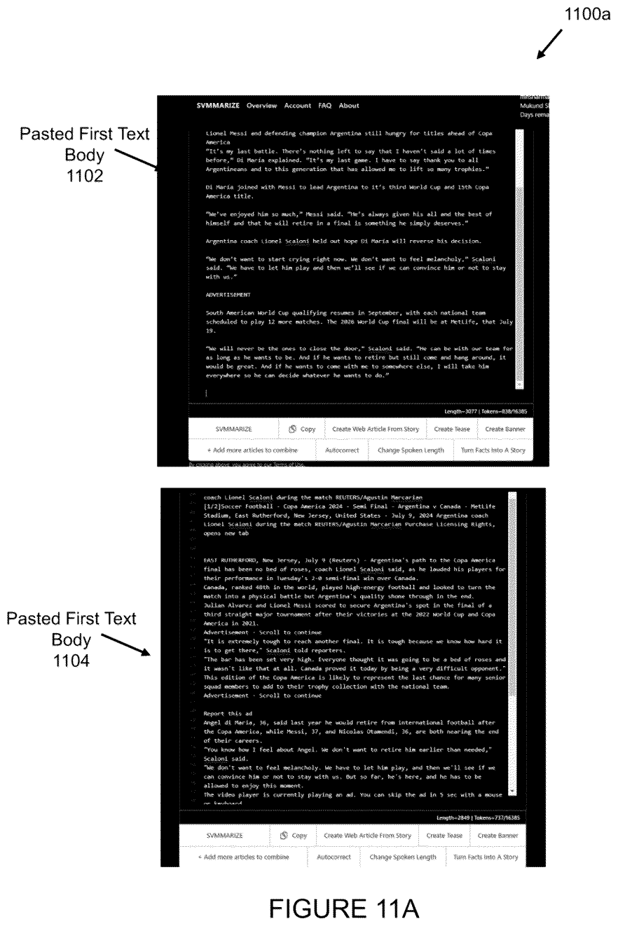

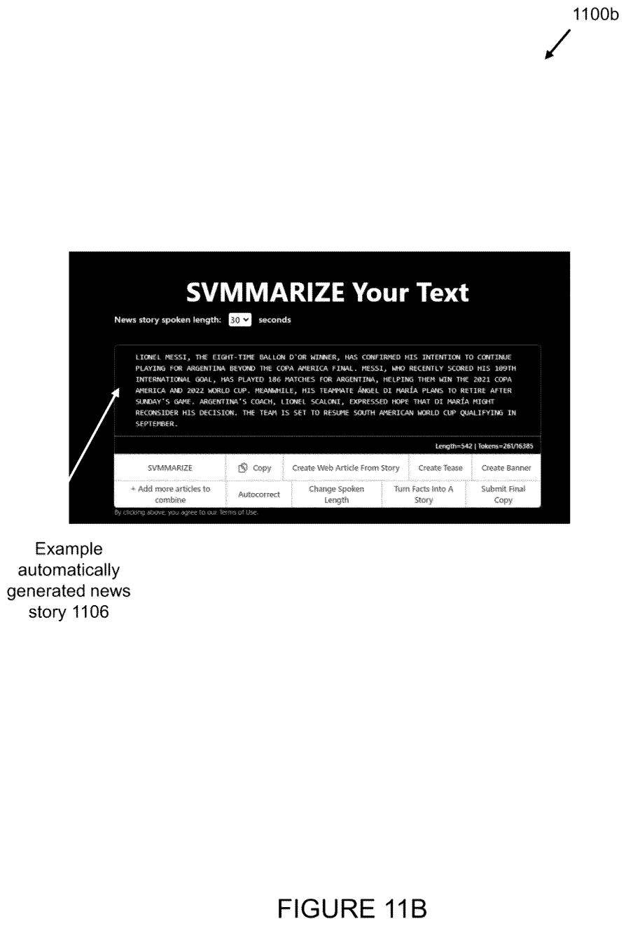

FIGS. 11A and 11B show example screen captures from a user interface of a processor-based system from which some aspects of the subject technology can be implemented. Pasted first text body 1102 corresponds to first source text 1002 and pasted second text body corresponds to second source text 1004. As shown in FIG. 11B, an example automatically generated news story 1106 has been generated using first source text 1002 and second source text 1004.

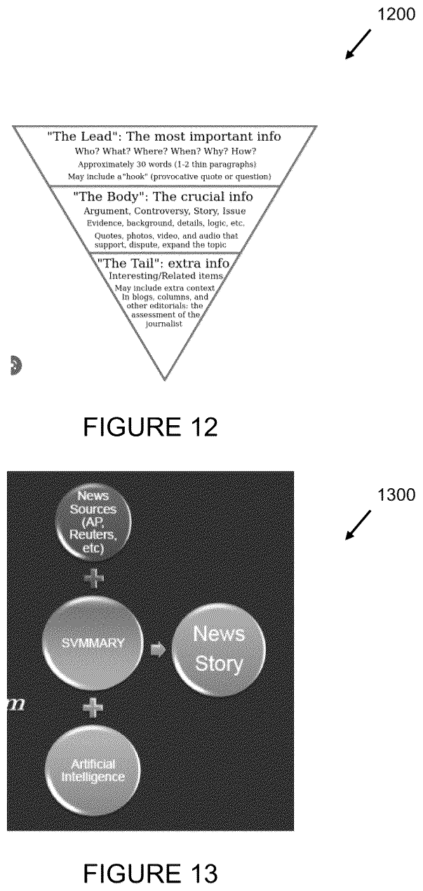

FIG. 12 shows an example 1200 of how some aspects of the subject technology analyze and/or organize information from one or more news sources into automatically summarized news content. FIG. 13 shows an example 1300 of how some aspects of the subject technology analyze and/or organize information from one or more news sources into automatically summarized news content. News sources, artificial intelligence, and a series of systematically engineered prompts can be used to automatically generate news stories conforming to one or more content parameters without human intervention.

FIG. 14 shows an example architecture 1400 of some aspects of the subject technology. The architecture 1400 includes: user 1402, news story generator 1404, credentialing module 1406, authorization and mail module 1408, Kong API gateway 1410, POstgREST API 1412, OpenAI data encryption layer 1414, REST API 1416, payment module 1418, PostGreSQL module 1422, and web service module 1422. It is noted that this is just an example architecture and that the systems and methods herein can take various forms and/or structures.

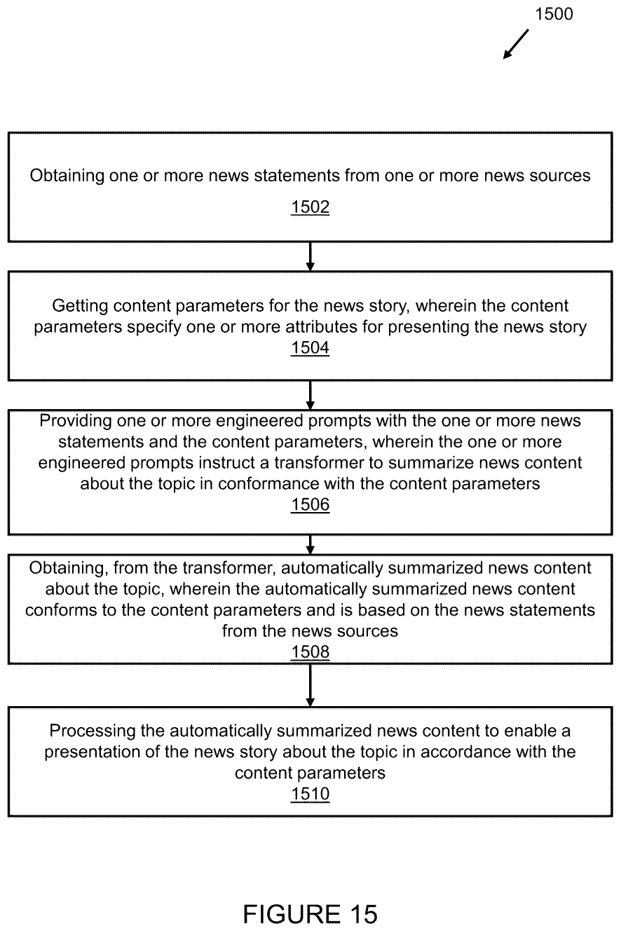

FIG. 15 illustrates a flowchart 1500 of a process for enabling a presentation of a news story using automatically summarized news content based on one or more sources, in accordance with some aspects of the subject technology.

At an operation 1502, one or more source texts from one or more news sources are obtained. At an operation 1504, content parameters for the news story are obtained, wherein the content parameters specify one or more attributes for presenting the news story. At an operation 1506, one or more engineered prompts with the one or more source texts and the content parameters are provided. The one or more engineered prompts instruct a transformer to summarize news content about the topic in conformance with the content parameters. At an operation 1508, automatically summarized news content about the topic is obtained from the transformer. The automatically summarized news content conforms to the content parameters and is based on the source texts from the news sources. At an operation 1510, the automatically summarized news content is processed to enable a presentation of the news story about the topic in accordance with the content parameters.

Illustrative examples of the disclosure include:

Aspect 1. An apparatus comprising: at least one memory; and at least one processor coupled to the at least one memory, the at least one processor configured to: receive a first source text, the source text having a first textual attribute; receive a content parameter; provide the source text and the content parameter to a machine-learning (ML) model; and receive, from the ML model, a proto text based on the source text and the content parameter, wherein the proto text has second textual attribute, and wherein the second word count is different than the first textual attribute.

Aspect 2. The apparatus of Aspect 1, wherein the content parameter specifies a maximum time duration for narration of the proto text having the second textual attribute.

Aspect 3. The apparatus of any of Aspects 1 to 2, wherein the at least one processor is further configured to: receive a style parameter; provide the proto text and the style parameter to the ML model; and receive, from the ML model, a stylized output text.

Aspect 4. The apparatus of Aspect 3, wherein the stylized output text has a third textual attribute, and wherein the third word count is different than the second textual attribute and the first textual attribute.

Aspect 5. The apparatus of any of Aspects 1 to 4, wherein the at least one processor is further configured to: receive a second source text; and provide the second source text to the ML model, and wherein the proto text is based on the first source text and the second source text.

Aspect 6. The apparatus of any of Aspects 1 to 5, wherein a number of phonemes in the proto text is based on the content parameter.

Aspect 7. The apparatus of any of Aspects 1 to 6, wherein the second textual attribute is based on the content parameter.

Aspect 8. The computer-implemented method of any of Aspects 1 to 7, wherein the content parameter comprises: a narrative length parameter to specify a length of a presentation, a duration parameter to specify duration of the presentation, a cadence parameter to specify a cadence of the presentation, a presentation speed parameter to specify a presentation speed of the presentation, a speech attribute parameter to specify speech attributes related to the presentation of content, a narrative style parameter to specify a narrative style of the presentation, or some combination thereof.

Aspect 9. The computer-implemented method of any of Aspects 1 to 8, wherein the first textual attribute comprises a first word count and the second textual attribute comprises a second word count.

Aspect 10. The computer-implemented method of any of Aspects 1 to 9, wherein the first textual attribute comprises a first word count, the second textual attribute comprises a second word count, and the second word count is less than the first word count.

Aspect 11. The computer-implemented method of any of Aspects 1 to 10, wherein the first textual attribute comprises a first word count, the second textual attribute comprises a second word count, and the second word count is greater than the first word count.

Aspect 12. A computer-implemented method comprising: receiving a first source text, the source text having a first textual attribute; receiving a content parameter; providing the source text and the content parameter to a machine-learning (ML) model; and receiving, from the ML model, a proto text based on the source text and the content parameter, wherein the proto text has second textual attribute, and wherein the second textual attribute is different than the first textual attribute.

Aspect 13. The computer-implemented method of Aspect 12, wherein the content parameter specifies a maximum time duration for narration of the proto text having the second textual attribute.

Aspect 14. The computer-implemented method of any of Aspects 12 to 13, further comprising: receiving a style parameter; providing the proto text and the style parameter to the ML model; and receiving, from the ML model, a stylized output text.

Aspect 15. The computer-implemented method of Aspect 14, wherein the stylized output text has a third textual attribute, and wherein the third textual attribute is different than the second textual attribute.

Aspect 16. The computer-implemented method of any of Aspects 12 to 15, further comprising: receiving a second source text; and providing the second source text to the ML model, and wherein the proto text is based on the first source text and the second source text.

Aspect 17. The computer-implemented method of any of Aspects 12 to 16, wherein a number of phonemes in the proto text is based on the content parameter.

Aspect 18. The computer-implemented method of any of Aspects 12 to 17, wherein the second textual attribute is based on the content parameter.

Aspect 19. A non-transitory computer-readable storage medium comprising at least one instruction for causing a computer or processor to: receive a first source text, the source text having a first textual attribute; receive a content parameter; provide the source text and the content parameter to a machine-learning (ML) model; and receive, from the ML model, a proto text based on the source text and the content parameter, wherein the proto text has second textual attribute, and wherein the second textual attribute is different than the first textual attribute.

Aspect 20. The non-transitory computer-readable storage medium of Aspect 19, wherein the content parameter specifies a maximum time duration for narration of the proto text having the second textual attribute.

Aspect 21. The non-transitory computer-readable storage medium of any of Aspects 19 to 20, wherein the at least one instruction is configured to cause the processor to: receive a style parameter; provide the proto text and the style parameter to the ML model; and receive, from the ML model, a stylized output text.

Aspect 22. The non-transitory computer-readable storage medium of Aspect 21, wherein the stylized output text has a third textual attribute, and wherein the third textual attribute is different than the second textual attribute.

Aspect 23. The non-transitory computer-readable storage medium of any of Aspects 21 to 22, wherein the at least one processor is further configured to: receive a second source text; and provide the second source text to the ML model, and wherein the proto text is based on the first source text and the second source text.

Aspect 24.non-transitory computer-readable storage medium of any of Aspects 21 to 23, wherein a number of phonemes in the proto text is based on the narrative length parameter.

Aspect 25. A computer-implemented method for automatically generating a news story about a topic, the computer-implemented method comprising: obtaining one or more source texts from one or more news sources; getting content parameters for the news story, wherein the content parameters specify one or more attributes for presenting the news story; providing one or more engineered prompts based on the one or more source texts and the content parameters, wherein the one or more engineered prompts instruct a transformer to summarize news content about the topic in conformance with the content parameters; obtaining, from the transformer, automatically summarized news content about the topic, wherein the automatically summarized news content conforms to the content parameters and is based on the source texts from the news sources; and processing the automatically summarized news content to enable a presentation of the news story about the topic in accordance with the content parameters.

Aspect 26. The method of Aspect 25, wherein the one or more engineered prompts comprise instructions structured to cause the transformer to generate the automatically summarized news content.

Aspect 27. The method of any of Aspects 25 to 26, wherein the one or more engineered prompts accord with a natural language processing (NLP) format.

Aspect 28. The method of any of Aspects 25 to 27, further comprising using the transformer to generate the summarized news content about the topic.

Aspect 29. The method of any of Aspects 25 to 28, wherein the transformer evaluates the source texts and the content parameters for relationships, contexts, or some combination thereof.

Aspect 30. The method of any of Aspects 25 to 29, wherein the transformer adds positional encodings to tokenized inputs based on the engineered prompts.

Aspect 31. The method of any of Aspects 25 to 30, wherein the transformer implements: masked multi-head attention, a feed-forward network, residual connections, layer normalizations, or some combination thereof.

Aspect 32. The method of any of Aspects 25 to 31, wherein the transformer maps one or more hidden states to token probabilities associated with the one or more source texts, the one or more content parameters, or some combination thereof.

Aspect 33. The method of any of Aspects 25 to 32, wherein the one or more news sources comprise a plurality of news sources.

Aspect 34. The method of any of Aspects 25 to 33, wherein the one or more source texts comprise news reports from a news service.

Aspect 35. The method of any of Aspects 25 to 34, wherein the content parameters specify a duration of the presentation of the news story, a cadence of the presentation of the news story, a presentation speed of the presentation of the news story, speech attributes related to the presentation of the news story, a narrative style of the presentation of the news story, or some combination thereof.

Aspect 36. The method of any of Aspects 25 to 35, wherein the content parameters specify a narrative style of the presentation of the news story, and the narrative style specifies an expository format, an editorial format, or some combination thereof.

Aspect 37. The method of any of Aspects 25 to 36, wherein the content parameters are related to one or more attributes of a presenter of the presentation of the news story.

Aspect 38. The method of any of Aspects 25 to 37, further comprising: storing the automatically summarized news content in a summarized news content file format.

Aspect 39. The method of any of Aspects 25 to 38, further comprising publishing the presentation of the news story.

Aspect 40. The method of any of Aspects 25 to 39, further comprising providing one or more annotations for a publication of the news story.

Aspect 41. The method of any of Aspects 25 to 40, further comprising incorporating one or more banners to annotate a publication of the news story.

Aspect 42. The method of any of Aspects 25 to 41, further comprising providing one or more voice over effects to annotate a publication of the news story.

Aspect 43. The method of any of Aspects 25 to 42, further comprising providing automated corrections to correct a publication of the news story based on the one or more source texts, the content parameters, or some combination thereof.

Aspect 44. The method of any of Aspects 25 to 43, further comprising processing one or more modifications of the content parameters to modify attributes of a publication of the news story.

Aspect 45. The method of any of Aspects 25 to 44, further comprising processing one or more modifications of the content parameters to modify attributes of a publication of the news story, wherein the attributes comprise one or more of a duration of the presentation of the news story, a cadence of the presentation of the news story, a presentation speed of the presentation of the news story, speech attributes related to the presentation of the news story, a narrative style of the presentation of the news story, or some combination thereof.

Aspect 46. A system comprising: one or more processors; and at least one memory coupled to the one or more processors, the at least one memory including computer-program instructions that, when executed by the one or more processors, cause the one or more processors to execute a computer-implemented method comprising: obtaining one or more source texts from one or more news sources; getting content parameters for the news story, wherein the content parameters specify one or more attributes for presenting the news story; providing one or more engineered prompts with the one or more source texts and the content parameters, wherein the one or more engineered prompts instruct a transformer to summarize news content about the topic in conformance with the content parameters; obtaining, from the transformer, automatically summarized news content about the topic, wherein the automatically summarized news content conforms to the content parameters and is based on the source texts from the news sources; and processing the automatically summarized news content to enable a presentation of the news story about the topic in accordance with the content parameters.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. An apparatus comprising:
at least one memory; and
at least one processor coupled to the at least one memory, the at least one processor configured to:
receive a first source text, the source text having a first textual attribute;
receive a content parameter;
provide the source text and the content parameter to a machine-learning (ML) model; and
receive, from the ML model, a proto text based on the source text and the content parameter, wherein the proto text has a second textual attribute, and wherein the second textual attribute is different than the first textual attribute.

2. The apparatus of claim 1, wherein the content parameter specifies a maximum time duration for narration of the proto text having the second textual attribute.

3. The apparatus of claim 1, wherein the at least one processor is further configured to:
receive a style parameter;
provide the proto text and the style parameter to the ML model; and
receive, from the ML model, a stylized output text.

4. The apparatus of claim 3, wherein the stylized output text has a third textual attribute, and wherein the third textual attribute is different than the second textual attribute and the first textual attribute.

5. The apparatus of claim 1, wherein the at least one processor is further configured to:
receive a second source text; and
provide the second source text to the ML model, and wherein the proto text is based on the first source text and the second source text.

6. The apparatus of claim 1, wherein a number of phonemes in the proto text is based on the content parameter.

7. The apparatus of claim 1, wherein the second textual attribute is based on the content parameter.

8. The apparatus of claim 1, wherein the content parameter comprises: a narrative length parameter to specify a length of a presentation, a duration parameter to specify duration of the presentation, a cadence parameter to specify a cadence of the presentation, a presentation speed parameter to specify a presentation speed of the presentation, a speech attribute parameter to specify speech attributes related to the presentation of content, a narrative style parameter to specify a narrative style of the presentation, or some combination thereof.

9. The apparatus of claim 1, wherein the first textual attribute comprises a first word count and the second textual attribute comprises a second word count.

10. The apparatus of claim 1, wherein the first textual attribute comprises a first word count, the second textual attribute comprises a second word count, and the second word count is less than the first word count.

11. The apparatus of claim 1, wherein the first textual attribute comprises a first word count, the second textual attribute comprises a second word count, and the second word count is greater than the first word count.

12. A computer-implemented method comprising:
receiving a first source text, the source text having a first textual attribute;
receiving a content parameter;
providing the source text and the content parameter to a machine-learning (ML) model; and
receiving, from the ML model, a proto text based on the source text and the content parameter, wherein the proto text has second textual attribute, and wherein the second textual attribute is different than the first textual attribute.

13. The computer-implemented method of claim 12, wherein the content parameter specifies a maximum time duration for narration of the proto text having the second textual attribute.

14. The computer-implemented method of claim 12, further comprising:
receiving a style parameter;
providing the proto text and the style parameter to the ML model; and
receiving, from the ML model, a stylized output text.

15. The computer-implemented method of claim 14, wherein the stylized output text has a third textual attribute, and wherein the third textual attribute is different than the second textual attribute.

16. The computer-implemented method of claim 12, further comprising:
receiving a second source text; and
providing the second source text to the ML model, and wherein the proto text is based on the first source text and the second source text.

17. The computer-implemented method of claim 12, wherein a number of phonemes in the proto text is based on the content parameter.

18. The computer-implemented method of claim 12, wherein the second textual attribute is based on the content parameter.

19. A non-transitory computer-readable storage medium comprising at least one instruction for causing a computer or processor to:
receive a first source text, the source text having a first textual attribute;
receive a content parameter;
provide the source text and the content parameter to a machine-learning (ML) model; and
receive, from the ML model, a proto text based on the source text and the content parameter, wherein the proto text has second textual attribute, and wherein the second textual attribute is different than the first textual attribute.

20. The non-transitory computer-readable storage medium of claim 19, wherein the content parameter specifies a maximum time duration for narration of the proto text having the second textual attribute.

21. The non-transitory computer-readable storage medium of claim 19, wherein the at least one instruction is configured to cause the processor to:
receive a style parameter;
provide the proto text and the style parameter to the ML model; and
receive, from the ML model, a stylized output text.

22. The non-transitory computer-readable storage medium of claim 21, wherein the stylized output text has a third textual attribute, and wherein the third textual attribute is different than the second textual attribute.

23. The non-transitory computer-readable storage medium of claim 21, wherein the at least one processor is further configured to:
receive a second source text; and
provide the second source text to the ML model, and wherein the proto text is based on the first source text and the second source text.

24. The non-transitory computer-readable storage medium of claim 21, wherein a number of phonemes in the proto text is based on the content parameter.

25. A computer-implemented method for automatically generating a news story about a topic, the computer-implemented method comprising:
obtaining one or more source texts from one or more news sources;
getting content parameters for the news story, wherein the content parameters specify one or more attributes for presenting the news story;
providing one or more engineered prompts based on the one or more source texts and the content parameters, wherein the one or more engineered prompts instruct a transformer to summarize news content about the topic in conformance with the content parameters;
obtaining, from the transformer, automatically summarized news content about the topic, wherein the automatically summarized news content conforms to the content parameters and is based on the source texts from the news sources; and
processing the automatically summarized news content to enable a presentation of the news story about the topic in accordance with the content parameters.

26. The method of claim 25, wherein the one or more engineered prompts comprise instructions structured to cause the transformer to generate the automatically summarized news content.

27. The method of claim 25, wherein the one or more engineered prompts accord with a natural language processing (NLP) format.

28. The method of claim 25, further comprising using the transformer to generate the summarized news content about the topic.

29. The method of claim 25, wherein the transformer evaluates the source texts and the content parameters for relationships, contexts, or some combination thereof.

30. The method of claim 25, wherein the transformer adds positional encodings to tokenized inputs based on the engineered prompts.

31. The method of claim 25, wherein the transformer implements: masked multi-head attention, a feed-forward network, residual connections, layer normalizations, or some combination thereof.

32. The method of claim 25, wherein the transformer maps one or more hidden states to token probabilities associated with the one or more source texts, the one or more content parameters, or some combination thereof.

33. The method of claim 25, wherein the one or more news sources comprise a plurality of news sources.

34. The method of claim 25, wherein the one or more source texts comprise news reports from a news service.

35. The method of claim 25, wherein the content parameters specify a duration of the presentation of the news story, a cadence of the presentation of the news story, a presentation speed of the presentation of the news story, speech attributes related to the presentation of the news story, a narrative style of the presentation of the news story, or some combination thereof.

36. The method of claim 25, wherein the content parameters specify a narrative style of the presentation of the news story, and the narrative style specifies an expository format, an editorial format, or some combination thereof.

37. The method of claim 25, wherein the content parameters are related to one or more attributes of a presenter of the presentation of the news story.

38. The method of claim 25, further comprising:
storing the automatically summarized news content in a summarized news content file format.

39. The method of claim 25, further comprising publishing the presentation of the news story.

40. The method of claim 25, further comprising providing one or more annotations for a publication of the news story.

41. The method of claim 25, further comprising incorporating one or more banners to annotate a publication of the news story.

42. The method of claim 25, further comprising providing one or more voice over effects to annotate a publication of the news story.

43. The method of claim 25, further comprising providing automated corrections to correct a publication of the news story based on the one or more source texts, the content parameters, or some combination thereof.

44. The method of claim 25, further comprising processing one or more modifications of the content parameters to modify attributes of a publication of the news story.

45. The method of claim 25, further comprising processing one or more modifications of the content parameters to modify attributes of a publication of the news story, wherein the attributes comprise one or more of a duration of the presentation of the news story, a cadence of the presentation of the news story, a presentation speed of the presentation of the news story, speech attributes related to the presentation of the news story, a narrative style of the presentation of the news story, or some combination thereof.

46. A system comprising:
one or more processors; and
at least one memory coupled to the one or more processors, the at least one memory including computer-program instructions that, when executed by the one or more processors, cause the one or more processors to execute a computer-implemented method comprising:
obtaining one or more source texts from one or more news sources for a news story;
getting content parameters for the news story, wherein the content parameters specify one or more attributes for presenting the news story;
providing one or more engineered prompts with the one or more source texts and the content parameters, wherein the one or more engineered prompts instruct a transformer to summarize news content about a topic in conformance with the content parameters;
obtaining, from the transformer, automatically summarized news content about the topic, wherein the automatically summarized news content conforms to the content parameters and is based on the source texts from the news sources; and
processing the automatically summarized news content to enable a presentation of the news story about the topic in accordance with the content parameters.
